(19) United States
(12) Patent Application Publication
(10) Pub. No.: US 2026/0039156 A1
(43) Pub. Date: Feb. 5, 2026

(54) NON-TRANSITORY COMPUTER-READABLE STORAGE MEDIUM, METHOD, INFORMATION PROCESSING DEVICE, AND SYSTEM

(71) Applicant: Aeterlink Corp., Tokyo (JP)

(72) Inventors: Ryosuke KUMAGAI, Tokyo (JP); Ken KATOGI, Tokyo (JP); Naoto KODATE, Tokyo (JP); Akito MURAI, Tokyo (JP)

(73) Assignee: Aeterlink Corp., Tokyo (JP)

(21) Appl. No.: 19/354,880

(22) Filed: Oct. 10, 2025

Related U.S. Application Data
(63) Continuation of application No. PCT/JP2024/006414, filed on Feb. 22, 2024.

(30) Foreign Application Priority Data
Apr. 13, 2023 (JP) 2023-065986

(51) Int. Cl. H02J 50/80; H02J 50/20; H02J 50/90

(52) U.S. Cl. CPC H02J 50/80; H02J 50/20; H02J 50/90

(57) ABSTRACT

A non-transitory computer-readable storage medium storing a program for causing a computer to execute processing including acquiring information regarding one or more transmitters configured to be placed in a predetermined space and configured to transmit a power-supply signal by radiating radio waves, and acquiring information regarding a power-transfer efficiency in the space, calculating, based on the information regarding the one or more transmitters and the information regarding the power-transfer efficiency, power intensity generated at one or more receivers configured to receive the power-supply signal at a plurality of positions in the space, and presenting a distribution of the calculated power intensity.

### CROSS-REFERENCE TO RELATED APPLICATIONS

This is a continuation of International Application No. PCT/JP2024/006414 filed on Feb. 22, 2024, and claims priority from Japanese Patent Application No. 2023-065986 filed on Apr. 13, 2023, the entire contents of each are incorporated herein by reference.

### TECHNICAL FIELD

This disclosure relates to a program, a method, an information processing apparatus, and a system.

### BACKGROUND ART

An apparatus for appropriately placing a power storage apparatus connected to a power system has been proposed (see JP2016-063720A). JP2016-063720A proposes a placement of a power storage apparatus that stores part of electric power supplied to a load section, based on a position determined according to weighting of information related to power demand of the load section.

While JP2016-063720A makes it possible to realize a highly reliable power supply system by enabling appropriate placement of a power storage apparatus, it does not describe placement of a wireless power transmission apparatus configured to supply electric power wirelessly to a load section.

### SUMMARY OF INVENTION

Aspect of non-limiting embodiments of the present disclosure relates to provide a program, a method, an information processing device, and a system to assist in determining a placement of a wireless power transmission apparatus that supplies electric power wirelessly to a power-supply target. Aspects of certain non-limiting embodiments of the present disclosure address the features discussed above and/or other features not described above.

However, aspects of the non-limiting embodiments are not required to address the above features, and aspects of the non-limiting embodiments of the present disclosure may not address features described above.

According to an aspect of the present disclosure, there is provided a non-transitory computer-readable storage medium storing a program for causing a computer to execute processing including:
acquiring information regarding one or more transmitters configured to be placed in a predetermined space and configured to transmit a power-supply signal by radiating radio waves, and acquiring information regarding a power-transfer efficiency in the space;
calculating, based on the information regarding the one or more transmitters and the information regarding the power-transfer efficiency, power intensity generated at one or more receivers configured to receive the power-supply signal at a plurality of positions in the space; and
presenting a distribution of the calculated power intensity.

### BRIEF DESCRIPTION OF DRAWINGS

Exemplary embodiment(s) of the present invention will be described in detail based on the following figures, wherein:

FIG. 1 is a diagram illustrating an overall configuration of a WPT system 1 according to an embodiment;

FIG. 2 is a block diagram illustrating an example configuration of a transmitter 100 and a receiver 200 shown in FIG. 1;

FIG. 3 is a block diagram illustrating an example configuration of a third information processing apparatus 500 shown in FIG. 1;

FIG. 4 is a schematic diagram illustrating an example data structure of rectifier information 582 stored in the third information processing apparatus 500;

FIG. 5 is a schematic diagram illustrating an example data structure of application information 583 stored in the third information processing apparatus 500;

FIG. 6 is a flowchart illustrating an example operation of the third information processing apparatus 500 when performing a simulation regarding placement of the transmitter 100;

FIG. 7 is a schematic diagram illustrating an example of a simulation process executed by the third information processing apparatus 500;

FIG. 8 is a schematic diagram illustrating an example display of an input form for information regarding conditions;

FIG. 9 is a diagram illustrating an example placement of the transmitter 100 in a space;

FIG. 10 is a diagram illustrating an example of simulation results of power intensity generated at a receiver 200 placed at a predetermined position;

FIG. 11 is a block diagram illustrating an example configuration of the third information processing apparatus 500 according to a first modification;

FIG. 12 is a flowchart illustrating another example operation of the third information processing apparatus 500 when performing a simulation regarding placement of the transmitter 100;

FIG. 13 is a diagram illustrating an example of information regarding a floor map input by a user;

FIG. 14 is a diagram illustrating an example placement of the transmitter 100 in a space;

FIG. 15 is a diagram illustrating an example of simulation results of power intensity generated at a receiver 200 placed at a predetermined position;

FIG. 16 is a block diagram illustrating an example configuration of the third information processing apparatus 500 according to a second modification;

FIG. 17 is a flowchart illustrating another example operation of the third information processing apparatus 500 when performing a simulation regarding placement of the transmitter 100;

FIG. 18 is a schematic diagram illustrating an example display of an input form for information regarding an application;

FIG. 19 is a diagram illustrating an example of simulation results of placement of the transmitter 100; and

FIG. 20 is a block diagram illustrating a basic hardware configuration of a computer 90.

### DESCRIPTION OF EMBODIMENTS

The embodiments of the present disclosure will be described below with reference to the drawings. In all of the drawings used to describe the embodiments, like reference numerals denote like components, and repeated description is omitted. The embodiments described below are not intended to unduly limit the scope of the present disclosure as set forth in the claims. Not all components shown in the embodiments are necessarily essential to the disclosure. The drawings are schematic and are not necessarily to scale.

### Overview

In a wireless power transfer (WPT) system, one or more transmitters transmit a power-supply signal, and multiple receivers receive the power-supply signal. An information processing apparatus simulates, for a receiver hypothetically located at an arbitrary position in a space, an intensity of electric power that would be generated by the power-supply signal transmitted by the one or more transmitters.

### <1. System-Level Configuration>

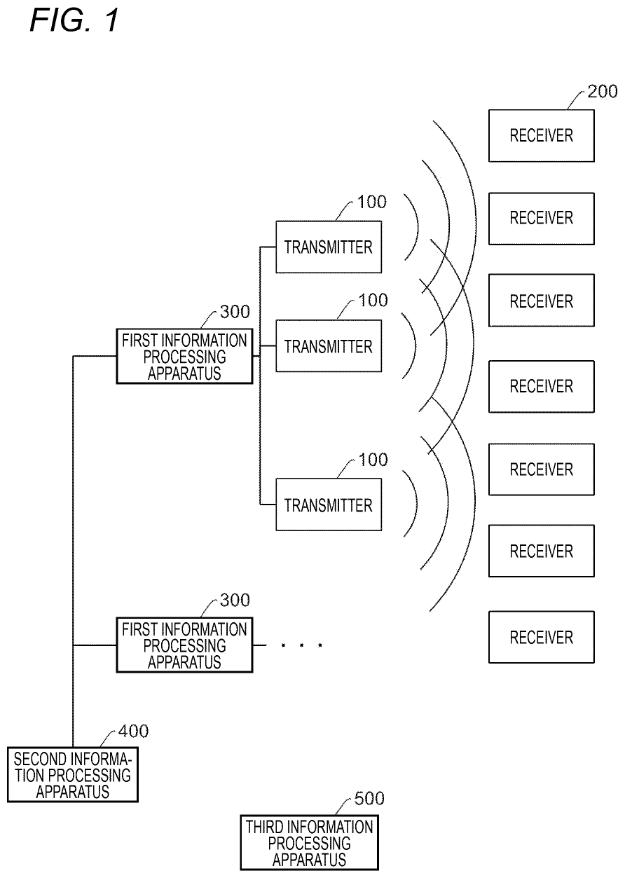

FIG. 1 is a diagram illustrating an overall configuration of a WPT system 1 according to the present embodiment.

As shown in FIG. 1, the WPT system 1 includes, for example, a transmitter 100, a receiver 200, a first information processing apparatus 300, a second information processing apparatus 400, and a third information processing apparatus 500. The WPT system 1 shown in FIG. 1 may be used, for example, in a building or a factory. A “building” is one example of a structure; any indoor space in which predetermined activities such as business or office work are performed may be used and is not limited to a building. Connections between the transmitter 100 and the first information processing apparatus 300, and between the first information processing apparatus 300 and the second information processing apparatus 400, may be either wired or wireless. The third information processing apparatus 500 may be connected to the first information processing apparatus 300 via a wired or wireless link. The third information processing apparatus 500 may also be connected to the second information processing apparatus 400 via a wired or wireless link.

In FIG. 1, an example is shown in which the WPT system 1 includes three transmitters 100; however, the number of transmitters 100 included in the WPT system 1 is not limited to three. The WPT system 1 may include two or fewer transmitters 100, or four or more transmitters 100.

In FIG. 1, an example is shown in which the WPT system 1 includes seven receivers 200; however, the number of receivers 200 included in the WPT system 1 is not limited to seven. The WPT system 1 may include six or fewer receivers 200, or eight or more receivers 200.

In FIG. 1, an example is shown in which the WPT system 1 includes two first information processing apparatuses 300; however, the number of first information processing apparatuses 300 included in the WPT system 1 is not limited to two. The WPT system 1 may include a single first information processing apparatus 300 or three or more first information processing apparatuses 300.

The transmitter 100 transmits, for example, a power-supply signal and/or a data signal to the receiver 200. For example, the transmitter 100 may transmit the power-supply signal to the receiver 200 using radio waves in the 920-MHz band, and may transmit the data signal to the receiver 200 using radio waves in the 2.4-GHz band. The transmitter 100 may alternatively transmit the data signal using radio waves in the 920-MHz band.

The transmitter 100 may transmit the power-supply signal to a single receiver 200 or to multiple receivers 200. The transmitter 100 may transmit the data signal to a single receiver 200 or to multiple receivers 200. The transmitter 100 may transmit the same data signal as another transmitter 100, or a data signal different from that of another transmitter 100. The transmitter 100 may transmit, as the data signal, a predetermined command signal to the receiver 200, or a preconfigured signal to the receiver 200.

The transmitter 100 receives, for example, a data signal transmitted from the receiver 200. The transmitter 100 may receive a data signal transmitted from a single receiver 200 or data signals transmitted from multiple receivers 200. The transmitter 100 transmits to the first information processing apparatus 300 the data signal received from the receiver 200. The transmitter 100 also transmits to the first information processing apparatus 300 information regarding a status of the transmitter 100.

The receiver 200 receives, for example, the power-supply signal and/or the data signal transmitted from the transmitter 100. When the receiver 200 includes a power storage unit, the receiver 200 converts the power-supply signal transmitted from the transmitter 100 into electric power and stores the converted electric power in the power storage unit. When the receiver 200 includes a predetermined sensor, the receiver 200 converts the power-supply signal transmitted from the transmitter 100 into electric power and drives the sensor with the converted electric power.

The receiver 200 transmits, as a data signal to the transmitter 100, information regarding a status of the receiver 200 and/or information regarding results measured by the sensor.

The first information processing apparatus 300 is an information processing apparatus that monitors operations of the transmitters 100 and the receivers 200 included in the WPT system 1. For example, based on information regarding statuses of the transmitters 100 and the receivers 200 that is transmitted from the transmitter 100, the first information processing apparatus 300 determines whether the transmitter 100 and/or the receiver 200 is in a predetermined state. When it is determined that the predetermined state is satisfied, the first information processing apparatus 300 transmits predetermined information to the second information processing apparatus 400.

The first information processing apparatus 300 also accumulates information regarding the transmitters 100 and the receivers 200 included in the WPT system 1. For example, the first information processing apparatus 300 stores, in a storage unit provided therein, information regarding statuses of the transmitters 100 and the receivers 200 that is transmitted from the transmitter 100.

The first information processing apparatus 300 further controls operations of the transmitters 100 included in the WPT system 1. For example, the first information processing apparatus 300 transmits predetermined instructions and/or information to the transmitter 100.

The first information processing apparatus 300 also controls operations of the second information processing apparatus 400.

The second information processing apparatus 400 is, for example, an information processing apparatus operated by an administrator of the WPT system 1. Upon receiving from the first information processing apparatus 300 a notification that the transmitter 100, the receiver 200, or both are in a predetermined state, the second information processing apparatus 400 presents to a user that the transmitter 100, the receiver 200, or both are in the predetermined state.

The second information processing apparatus 400 also analyzes information regarding statuses of the transmitters 100 and the receivers 200 that is accumulated in the first information processing apparatus 300, and presents predetermined information to the user. Examples of the predetermined information include:
information regarding placement of the transmitters 100; information regarding placement of the receivers 200; information regarding power consumption; and information regarding power intensity.

The third information processing apparatus 500 is, for example, an information processing apparatus operated by a user who is considering deployment of the WPT system 1. In other words, the third information processing apparatus 500 may be an information processing apparatus operated by a user considering construction of the WPT system 1. The third information processing apparatus 500 simulates, for example, an electric-power environment that can be provided in an indoor space. Specifically, for a space in which the WPT system 1 is to be constructed, the third information processing apparatus 500 simulates an intensity of electric power generated at the receiver 200 by the power-supply signal transmitted by the transmitter 100. The third information processing apparatus 500 need not be a standalone information processing apparatus. The functions of the third information processing apparatus 500 may, for example, be provided by the second information processing apparatus 400.

### <1.1 Configuration of the Transmitter and the Receiver>

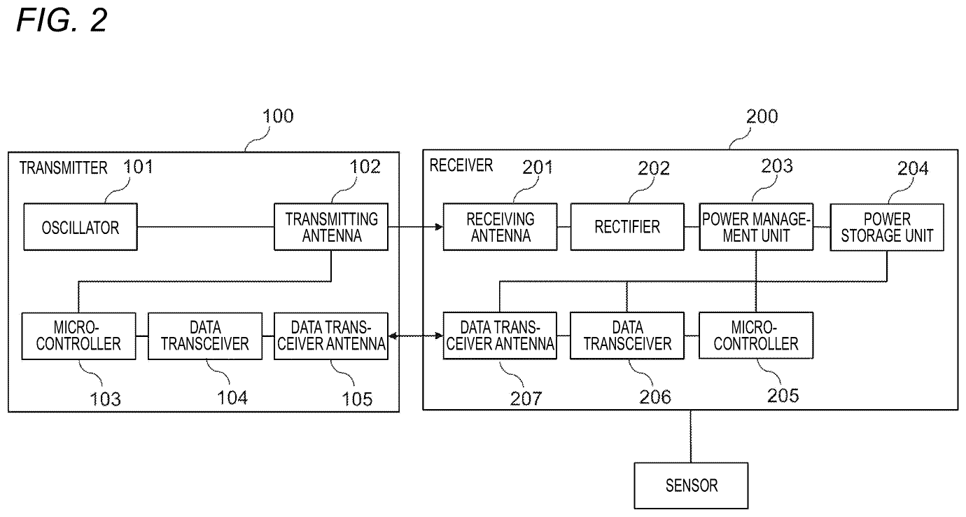

FIG. 2 is a block diagram illustrating an example configuration of the transmitter 100 and the receiver 200 shown in FIG. 1. As shown in FIG. 2, the transmitter 100 and the receiver 200 are spaced apart from each other at a predetermined interval. For example, the transmitter 100 and the receiver 200 may be installed at a distance on the order of several meters. More specifically, the transmitter 100 may be fixedly installed at a high position indoors, such as on a ceiling or at an elevated position on a wall. Depending on the manner of installation, the transmitter 100 may be repositionable after installation. The receiver 200 may be installed on a predetermined device indoors or placed in the vicinity of a device requiring power. The receiver 200 may also be carried by a user. Depending on the manner of installation, the receiver 200 may be repositionable after installation. The transmitter 100 transmits a power-supply signal to the receiver 200 using radio waves at a predetermined frequency, for example, in the 920-MHz band. The receiver 200 converts the power-supply signal transmitted from the transmitter 100 into electric power and either charges using the converted power or supplies the converted power to a predetermined device.

The transmitter 100 includes, for example, an oscillator 101, a transmitting antenna 102, a microcontroller 103, a data transceiver 104, and a data transceiver antenna 105. At least one of the oscillator 101, the microcontroller 103, the data transceiver 104, the data transceiver antenna 105, and any combination thereof may be mounted on a printed circuit board (PCB).

The oscillator 101 oscillates a signal in a predetermined frequency band, for example, the 920-MHz band. The oscillated signal may be amplified as needed, and unwanted frequency components may be removed.

The transmitting antenna 102 is formed so as to efficiently transmit radio waves, for example, in the 920-MHz band. The transmitting antenna 102 radiates, as the power-supply signal, a signal modulated by a modulator 107.

The microcontroller 103 controls operations of the transmitter 100. The microcontroller 103 may be implemented by, for example, a single-board computer equipped with an ARM processor. The microcontroller 103 controls, for example, transmission of radio waves by the transmitting antenna 102.

The data transceiver 104 performs processing such as digital-to-analog conversion of digital data and modulation of analog data. The data transceiver 104 also performs processing such as demodulation of data signals received by the data transceiver antenna 105 and digitization of the demodulated data. For example, the data transceiver 104 extracts a predetermined signal from a data signal received by the data transceiver antenna 105, converts the extracted signal into digital data, and transmits the digital data to the microcontroller 103.

The data transceiver antenna 105 is formed so as to efficiently transmit and receive radio waves, for example, in the 2.4-GHz band. The data transceiver antenna 105 radiates a data signal supplied from the data transceiver 104 and receives a data signal transmitted from the receiver 200.

The receiver 200 includes, for example, a receiving antenna 201, a rectifier 202, a power management unit 203, a power storage unit 204, a microcontroller 205, a data transceiver 206, and a data transceiver antenna 207. At least one of the receiving antenna 201, the rectifier 202, the power management unit 203, the power storage unit 204, the microcontroller 205, the data transceiver 206, the data transceiver antenna 207, and any combination thereof may be mounted on a PCB or on a flexible printed circuit (FPC).

The receiving antenna 201 is formed so as to efficiently receive radio waves, for example, in the 920-MHz band. The receiving antenna 201 receives the power-supply signal radiated from the transmitting antenna 102.

The rectifier 202 rectifies the radio wave received as the power-supply signal and converts it into a direct-current (DC) voltage.

The power management unit 203 manages the DC voltage. For example, the power management unit 203 controls a charging voltage based on the DC voltage. By controlling the charging voltage, the power management unit 203 charges the power storage unit 204. In addition, when a predetermined capacity or more of electric power is stored in the power storage unit 204, the power management unit 203 supplies the DC voltage to a connected component.

The power management unit 203 also causes electric power stored in the power storage unit 204 to be discharged in response to control from the microcontroller 205.

The power storage unit 204 stores electric power in response to an instruction from the power management unit 203. The power storage unit 204 may be implemented, for example, by a battery or a capacitor. The power storage unit 204 also discharges stored electric power in response to an instruction from the power management unit 203.

The microcontroller 205 controls operations of the receiver 200. The microcontroller 205 is driven by the DC voltage supplied from the power management unit 203 or by electric power stored in the power storage unit 204. The microcontroller 205 controls the power management unit 203 to cause electric power stored in the power storage unit 204 to be discharged.

Various sensors can be connected to the receiver 200. For example, a heat-flux sensor, a temperature sensor, a light sensor, a humidity sensor, and a vibration sensor may be connected to the receiver 200. A sensor connected to the receiver 200 is driven by the DC voltage supplied from the power management unit 203 or by electric power discharged from the power storage unit 204. The microcontroller 205 continuously or intermittently monitors, for example, a voltage value at a predetermined portion of the receiver 200, a status of a sensor connected to the receiver 200, and information detected by the sensor. The microcontroller 205 transmits, as digital data to the data transceiver 206, the voltage value at the predetermined portion of the receiver 200, the status of the sensor connected to the receiver 200, and the information detected by the sensor. A sensor may be built in the receiver 200.

The data transceiver 206 performs processing such as digital-to-analog conversion of digital data supplied from the microcontroller 205 and modulation of analog data. The data transceiver 206 also performs processing such as demodulation of data signals received by the data transceiver antenna 207 and digitization of the demodulated data. The data transceiver 206 is driven, for example, by the DC voltage supplied from the power management unit 203 or by electric power discharged from the power storage unit 204.

The data transceiver antenna 207 is formed so as to efficiently transmit and receive radio waves, for example, in the 2.4-GHz band. The data transceiver antenna 207 radiates a data signal supplied from the data transceiver 206 and receives a data signal transmitted from the transmitter 100. For example, the data transceiver 206 is driven by the DC voltage supplied from the power management unit 203 or by electric power discharged from the power storage unit 204.

### <1.2 Configuration of the Third Information Processing Apparatus>

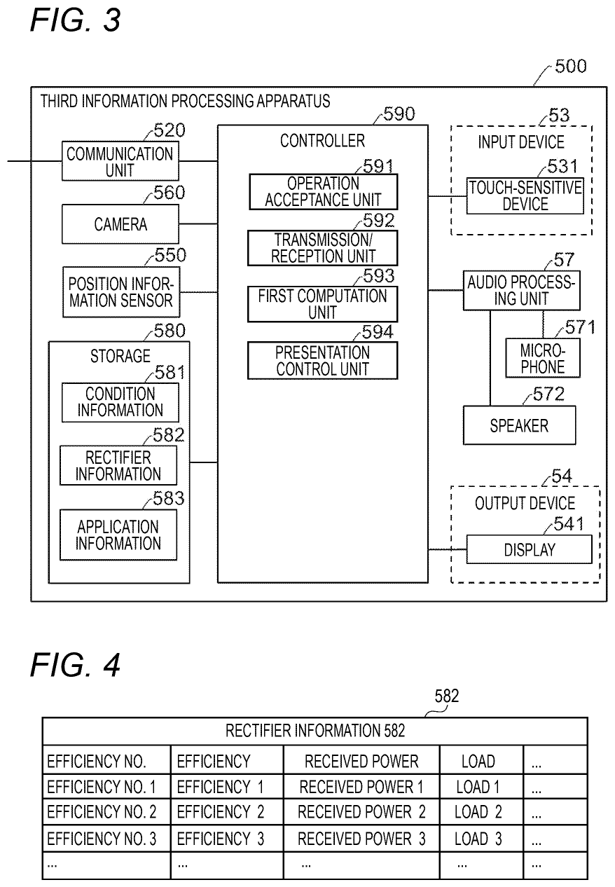

FIG. 3 is a block diagram illustrating an example configuration of the third information processing apparatus 500 shown in FIG. 1. As shown in FIG. 3, the third information processing apparatus 500 includes a communication unit 520, an input device 53, an output device 54, an audio processing unit 57, a microphone 571, a speaker 572, a camera 560, a position information sensor 550, a storage 580, and a controller 590. The respective blocks included in the third information processing apparatus 500 are electrically connected via, for example, a bus.

The communication unit 520 performs processing such as modulation/demodulation for communication between the third information processing apparatus 500 and another apparatus. The communication unit 520 applies transmission processing to a signal generated by the controller 590 and transmits the signal to an external apparatus (for example, the first information processing apparatus 300). The communication unit 520 applies reception processing to a signal received from an external apparatus and outputs the processed signal to the controller 590.

The input device 53 is a device through which a user operating the third information processing apparatus 500 inputs instructions and/or information. The input device 53 may be implemented by, for example, a touch-sensitive device 531 that receives an instruction by contact with an operation surface. When the third information processing apparatus 500 is a personal computer or the like, the input device 53 may alternatively be implemented by a reader, a keyboard, a mouse, or the like. The input device 53 converts an instruction input by a user into an electric signal and outputs the electric signal to the controller 590. The input device 53 may include, for example, an input port that accepts an electric signal input from an external input device.

The output device 54 is a device that presents information to a user operating the third information processing apparatus 500. The output device 54 may be implemented by, for example, a display 541. The display 541 displays data in accordance with control by the controller 590. The display 541 may be implemented by, for example, a liquid crystal display (LCD) or an organic electroluminescence (EL) display (OLED).

The audio processing unit 57 performs, for example, digital-to-analog conversion processing of audio signals. The audio processing unit 57 converts a signal provided from the microphone 571 into a digital signal and provides the converted signal to the controller 590. The audio processing unit 57 also provides an audio signal to the speaker 572. The audio processing unit 57 may be implemented by a processor dedicated to audio processing. The microphone 571 receives audio input and provides to the audio processing unit 57 an audio signal corresponding to the audio input. The speaker 572 converts an audio signal provided from the audio processing unit 57 into sound and outputs the sound to the outside of the third information processing apparatus 500.

The camera 560 is a device that receives light via a photosensor and outputs a capture signal.

The position information sensor 550 is a sensor that detects a position of the third information processing apparatus 500, and is, for example, a GPS (Global Positioning System) module. A GPS module is a receiving device used in a satellite positioning system. In the satellite positioning system, signals from at least three or four satellites are received, and a current position of the third information processing apparatus 500 on which the GPS module is mounted is detected based on the received signals. The position information sensor 550 may detect the current position of the third information processing apparatus 500 based on positions of wireless base stations to which the third information processing apparatus 500 is connected.

The storage 580 is implemented by, for example, a memory 55 and a storage 56, and stores data and programs used by the third information processing apparatus 500. The storage 580 stores, for example, condition information 581, rectifier information 582, and application information 583.

The condition information 581 includes, for example, information regarding conditions related to the WPT system 1. Specifically, the condition information 581 includes information regarding conditions of devices that construct the WPT system 1. The information regarding conditions of devices includes, for example, information regarding positions of the transmitters 100 to be placed in a space related to the WPT system 1. The information regarding positions of the transmitters 100 includes, for example, placement intervals of the transmitters 100. The information regarding conditions of devices includes, for example, information regarding placement of the transmitters 100 in the space related to the WPT system 1. The information regarding conditions of devices includes information regarding the number of the transmitters 100 to be placed in the space related to the WPT system 1. The information regarding conditions of devices further includes, for example, information regarding the transmitters 100. The information regarding the transmitters 100 includes, for example, information regarding an intensity (transmit power) of radio waves transmitted by the transmitters 100. The information regarding the transmitters 100 includes, for example, information regarding efficiency (antenna gain) of the transmitting antennas 102 of the transmitters 100. The information regarding efficiency of the transmitting antennas 102 is affected, for example, by beam shape and polarization. The information regarding the transmitters 100 may further include information regarding a mounting height at which each transmitter 100 is installed.

The information regarding conditions of devices includes, for example, information regarding the receivers 200. The information regarding the receivers 200 includes, for example, information regarding efficiency (antenna gain) of the receiving antennas 201 of the receivers 200. The information regarding efficiency of the receiving antennas 201 is affected, for example, by beam shape and polarization. The information regarding the receivers 200 includes, for example, information regarding efficiency of the rectifiers 202 of the receivers 200. The information regarding the receivers 200 may further include information regarding a mounting height at which each receiver 200 is installed.

The information regarding the receivers 200 may further include information regarding a movement range of the receivers 200. The information regarding the receivers 200 may further include information regarding installation conditions of the receivers 200. In some cases, the receivers 200 are affected by radio-wave directivity. In such cases, reception performance varies depending on a position at which a receiver 200 is installed (or placed). That is, reception performance differs depending on whether the receiver 200 is placed vertically or horizontally. The information regarding the receivers 200 may include parameters that enable consideration of differences in reception performance depending on installation configurations of the receivers 200.

The information regarding conditions of devices may be pre-stored or may be set by a user. The information regarding conditions of devices is not limited to the foregoing. For example, any of the above may be omitted, and information other than the above may be included.

The condition information 581 further includes information regarding environmental conditions of a space in which the WPT system 1 is constructed. The information regarding environmental conditions includes, for example, information regarding materials that form the space. The information regarding materials that form the space includes, for example, a floor material, a ceiling material, a wall material, a window glass material, or any combination of at least some of these. The information regarding environmental conditions includes, for example, information regarding objects placed in the space. The information regarding objects placed in the space includes, for example, positions of objects such as desks and chairs, types of the objects, materials of the objects, or any combination of at least some of these. The information regarding environmental conditions may be pre-stored or may be set by a user. The information regarding environmental conditions is not limited to the foregoing. For example, any of the above may be omitted, and information other than the above may be included.

The condition information 581 further includes information regarding a loss of radio-wave intensity in the space. The loss of radio-wave intensity and power transfer efficiency are reciprocals of each other. The loss of radio-wave intensity may be a preset value, or may vary based on the environmental conditions of the space in which the WPT system 1 is constructed.

The rectifier information 582 includes information regarding efficiency of the rectifier 202. For example, the efficiency of the rectifier 202 varies depending on a strength of a power-supply signal received by the receiver 200 and a magnitude of a load connected to the receiver 200 (a magnitude of a load of an application executed by electric power generated at the receiver 200). The rectifier information 582 stores, for example, a relationship among power of the power-supply signal provided to the receiver 200, the magnitude of the load connected to the receiver 200, and the efficiency of the rectifier 202. Details will be described later.

The application information 583 includes information regarding applications that are driven by electric power generated by the power-supply signal. Details will be described later.

The controller 590 is implemented when a processor reads a program stored in the storage 580 and executes instructions included in the program. The controller 590 controls operations of the third information processing apparatus 500. By operating in accordance with the program, the controller 590 functions as an operation acceptance unit 591, a transmission/reception unit 592, a first computation unit 593, and a presentation control unit 594.

The operation acceptance unit 591 performs processing to accept instructions and/or information input from the input device 53. Specifically, the operation acceptance unit 591 accepts instructions and/or information input from, for example, the touch-sensitive device 531.

The operation acceptance unit 591 also accepts voice instructions input from the microphone 571. Specifically, the operation acceptance unit 591 receives an audio signal that is input from the microphone 571 and converted into a digital signal by the audio processing unit 57. The operation acceptance unit 591 acquires a user's instruction by, for example, analyzing the received audio signal and extracting a predetermined noun.

The transmission/reception unit 592 performs processing to transmit and receive data, in accordance with a communication protocol, between the third information processing apparatus 500 and external devices such as the first information processing apparatus 300 and the second information processing apparatus 400. Specifically, the transmission/reception unit 592 transmits an instruction input by a user to the first information processing apparatus 300 or the second information processing apparatus 400. The transmission/reception unit 592 also receives information provided from the first information processing apparatus 300 or the second information processing apparatus 400.

The first computation unit 593 calculates, in a predetermined space in which the WPT system 1 is constructed, an intensity of electric power generated at a receiver 200 placed at a predetermined position by a power-supply signal transmitted from the transmitter 100.

Specifically, the first computation unit 593 calculates the intensity of electric power generated at the receiver 200 placed at the predetermined position based on conditions related to the WPT system 1. More specifically, the first computation unit 593 calculates the intensity of electric power generated at the receiver 200 placed at the predetermined position based on information regarding conditions of devices and a loss of radio-wave intensity in the space.

Still more specifically, the first computation unit 593 calculates the intensity of electric power generated at the receiver 200 placed at the predetermined position based on information regarding positions of one or more transmitters 100 to be placed in the space related to the WPT system 1, information regarding the number of the transmitters 100 to be placed, information regarding an intensity (transmit power) of radio waves transmitted from the transmitters 100, information regarding efficiency of the transmitting antenna 102 of the transmitter 100, information regarding efficiency of the receiving antenna 201 of the receiver 200 assumed to be placed at the predetermined position, and information regarding efficiency of the rectifier 202 of the receiver 200. In other words, the first computation unit 593 calculates the intensity of electric power generated at the receiver 200 placed at the predetermined position, to which radio waves transmitted from the one or more transmitters 100 arrive while attenuating. The first computation unit 593 calculates the power intensity for each region obtained by dividing the space into regions of a predetermined size. The manner of division of the space is not limited; for example, a mesh division or another shape may be employed.

The calculation of power intensity by the first computation unit 593 may be expressed by the following equation, for example:

Σ(0˜N)_Pout=Σ(0˜N)_(Pin*E_air(N)*E_TxAnt*E_RxAnt*E_rect) (1)

In Equation (1), N denotes the number of the transmitters 100 to be placed; Pin denotes a power intensity (transmit power) of radio waves transmitted from the transmitter 100; E_TxAnt denotes efficiency of the transmitting antenna 102; E_RxAnt denotes efficiency of the receiving antenna 201; E_rect denotes efficiency of the rectifier 202; and E_air(N) denotes a loss factor in space (propagation factor) applicable to radio waves from the transmitter 100. The first computation unit 593 calculates the power intensity for each region obtained by dividing the space into regions of a predetermined size using Equation (1).

The efficiency E_rect of the rectifier 202 may be preset, may be set by a user, or may be derived based on predetermined parameters. For example, the first computation unit 593 derives the efficiency of the rectifier 202 by referencing the rectifier information 582 using a strength of the power-supply signal that arrives at the receiver 200 from the one or more transmitters 100 and a magnitude of a load of an application executed by electric power generated at the receiver 200. Using the derived efficiency of the rectifier 202, the first computation unit 593 calculates, for example in accordance with Equation (1), the intensity of electric power generated at the receiver 200.

The loss of radio-wave intensity in the space can be affected by the environmental conditions of the space in which the WPT system 1 is constructed. The first computation unit 593 reflects the information regarding the environmental conditions in the loss of radio-wave intensity in the space. The first computation unit 593 calculates the intensity of electric power generated at the receiver 200 placed at the predetermined position based on the information regarding conditions of devices and the loss reflecting the environmental conditions.

The presentation control unit 594 controls the output device 54 to present calculated information to a user. Specifically, the presentation control unit 594 causes the display 541 to display the power intensity calculated for each region obtained by dividing the space into regions of a predetermined size. The presentation control unit 594 also causes the display 541 to display the power intensity calculated for each region overlaid at corresponding positions on a floor map.

The presentation control unit 594 causes the display 541 to display available applications (e.g., a heat sensor, a temperature sensor, a light sensor, a humidity sensor, and a vibration sensor) based on the power intensity calculated for each region.

### <2. Data Structures>

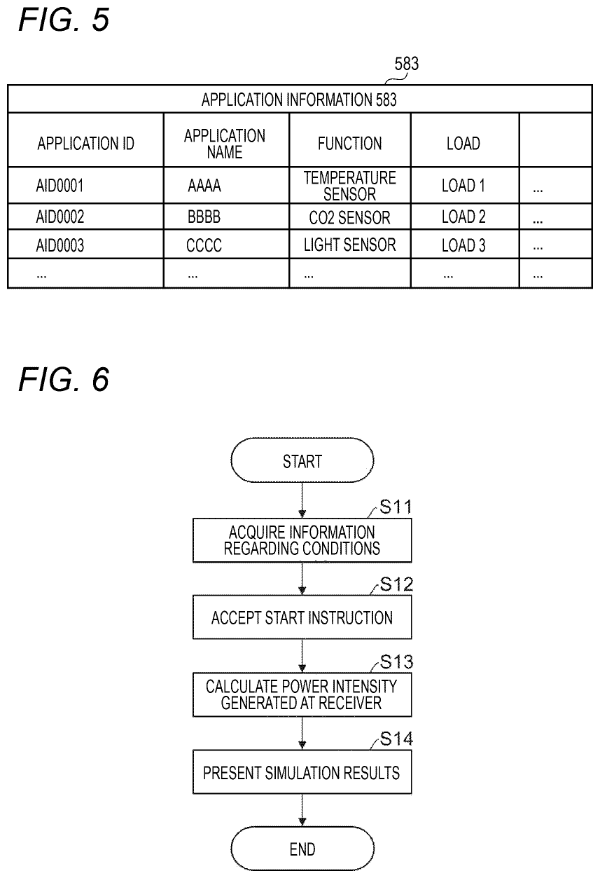

FIGS. 4 and 5 are diagrams illustrating data structures of tables stored by the third information processing apparatus 500. It is noted that FIGS. 4 and 5 are merely examples and do not exclude data not depicted. Even data items belonging to the same table may be stored in separate storage areas in the storage 580.

FIG. 4 is a schematic diagram illustrating an example data structure of the rectifier information 582 stored in the third information processing apparatus 500. The rectifier information 582 shown in FIG. 4 is a table having columns of “Efficiency No.,” “Efficiency,” “Received Power,” and “Load,” using the “Efficiency No.” as a key, for example. The rectifier information 582 shown in FIG. 4 represents a relationship among efficiency, received power, and load.

“Efficiency No.” is a field that stores number for identifying an efficiency entry. “Efficiency” is a field that stores the efficiency of the rectifier 202. “Received Power” is a field that stores a strength of the power-supply signal received by the receiver 200. “Load” is a field that stores a load of an application executed by the receiver 200.

FIG. 5 is a schematic diagram illustrating an example data structure of the application information 583 stored in the third information processing apparatus 500. The application information 583 shown in FIG. 5 is a table having columns of “Application ID,” “Application Name,” “Function,” and “Load,” using the “Application ID” as a key, for example.

“Application ID” is a field that stores identification information of an application. “Application Name” is a field that stores a name of the application. “Function” is a field that stores a function of the application. For example, one of a heat sensor, a temperature sensor, a light sensor, a humidity sensor, and a vibration sensor is stored in the “Function” field. “Load” is a field that stores a load of an application executed by the receiver 200.

### <3. Operation>

FIG. 6 is a flowchart illustrating an example operation of the third information processing apparatus 500 when performing a simulation regarding placement of the transmitter 100.

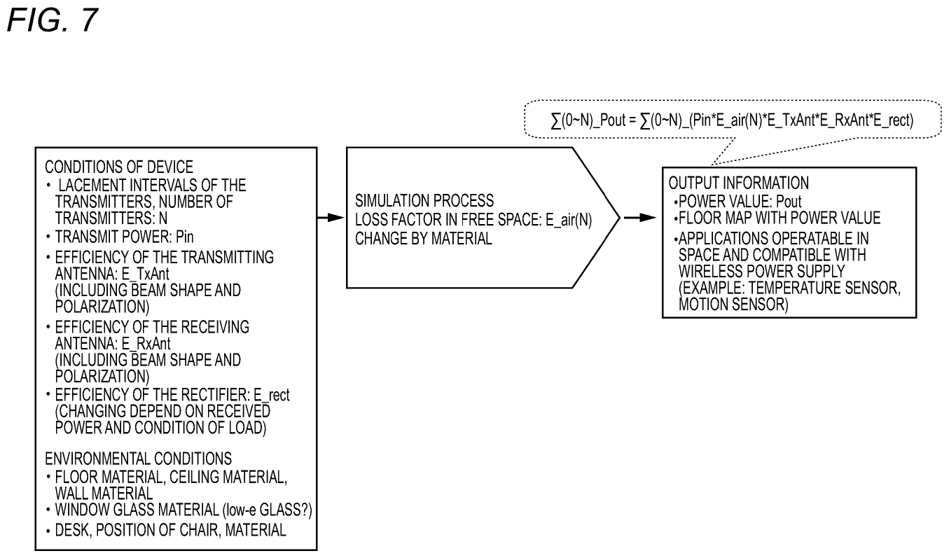

FIG. 7 is a schematic diagram illustrating an example of a simulation process executed by the third information processing apparatus 500.

In step S11, the third information processing apparatus 500 acquires, from a user, information regarding conditions related to the WPT system 1. Specifically, the controller 590 of the third information processing apparatus 500 causes, via the presentation control unit 594, an input form for entering conditions to be displayed on the display 541. The user operates the input device 53 and enters necessary information. The operation acceptance unit 591 accepts the information entered by the user.

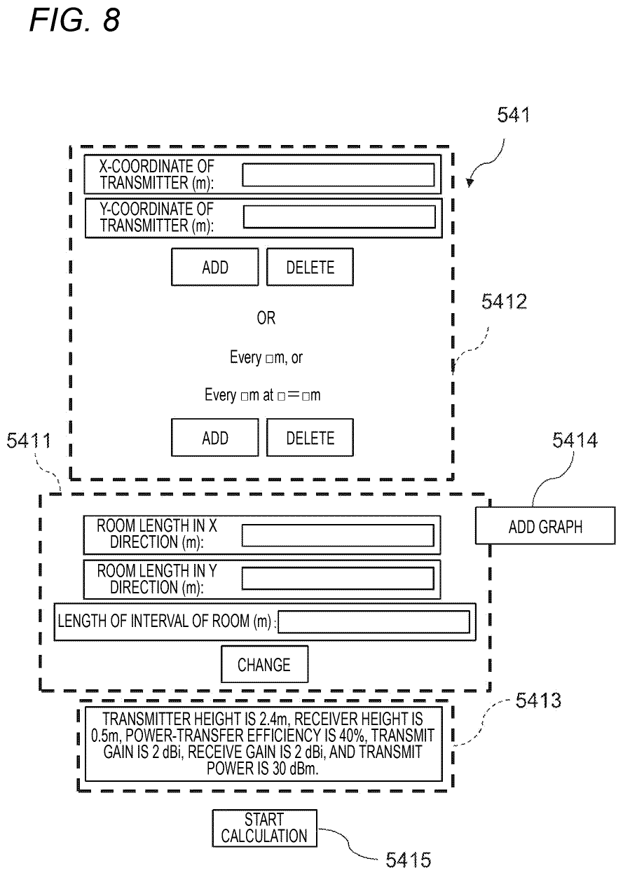

FIG. 8 is a schematic diagram illustrating an example display of the input form for information regarding conditions. In the example shown in FIG. 8, a first region 5411 for accepting input of information regarding a space is displayed. In the first region 5411, for example, a room length in the x direction, a room length in the y direction, and a grid interval of the room are accepted. In the example shown in FIG. 8, a second region 5412 for accepting input of number and a placement of the transmitters 100 is also displayed. In addition, a third region 5413 for displaying parameters that have been set is displayed. In the third region 5413, for example, “transmitter height: 2.4 m, receiver height: 0.5 m, power-transfer efficiency: 40%, transmit gain: 2 dBi, receive gain: 2 dBi, transmit power: 30 dBm” are set. The information in the third region 5413 may be variable in response to a user instruction.

In the example shown in FIG. 8, a control 5414 for instructing generation of a diagram representing a placement of the transmitters 100 in the space is displayed. When information regarding the space is accepted in the first region 5411, input of the number and a placement of the transmitters 100 is accepted in the second region 5412, and a user instruction on the control 5414 is accepted, the presentation control unit 594 generates, based on the entered information, a diagram representing the placement of the transmitters 100 in the space. The presentation control unit 594 causes the generated diagram to be displayed on the display 541.

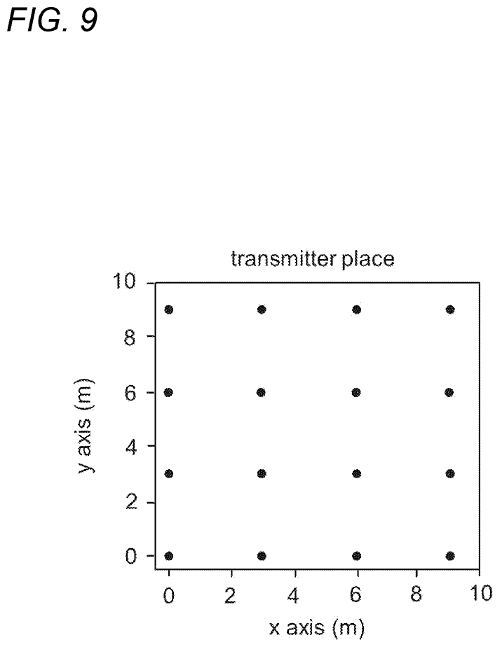

FIG. 9 is a diagram illustrating an example placement of the transmitters 100 in the space. With reference to the diagram representing the placement of the transmitters 100, a user can intuitively grasp the placement of the transmitters 100.

In step S12, the third information processing apparatus 500 accepts, from the user, a start instruction for the simulation. Specifically, in the example shown in FIG. 8, a control (button) 5415 for starting a simulation regarding placement of the transmitters 100 is displayed. After entering information regarding the space in the first region 5411 and entering the number and a placement of the transmitters 100 in the second region 5412, the user presses the control 5415. The operation acceptance unit 591 accepts the pressing of the control 5415 as a start instruction for the simulation.

In step S13, the third information processing apparatus 500 calculates a power intensity generated at a receiver 200 placed at a predetermined position by a power-supply signal transmitted from the transmitter 100. Specifically, for example, the controller 590 simulates, via the first computation unit 593, transmission of radio waves from the transmitters 100 placed at positions entered in the second region 5412, for the space entered in the first region 5411. The first computation unit 593 calculates, based on other parameters that have been preset, the power intensity generated at the receivers 200 placed in respective regions obtained by dividing the space into regions of a predetermined size by the radio waves transmitted from the transmitters 100.

In step S14, the third information processing apparatus 500 presents simulation results to the user. Specifically, the controller 590 causes, via the presentation control unit 594, the power intensity calculated for each region obtained by dividing the space into regions of a predetermined size to be displayed on the display 541.

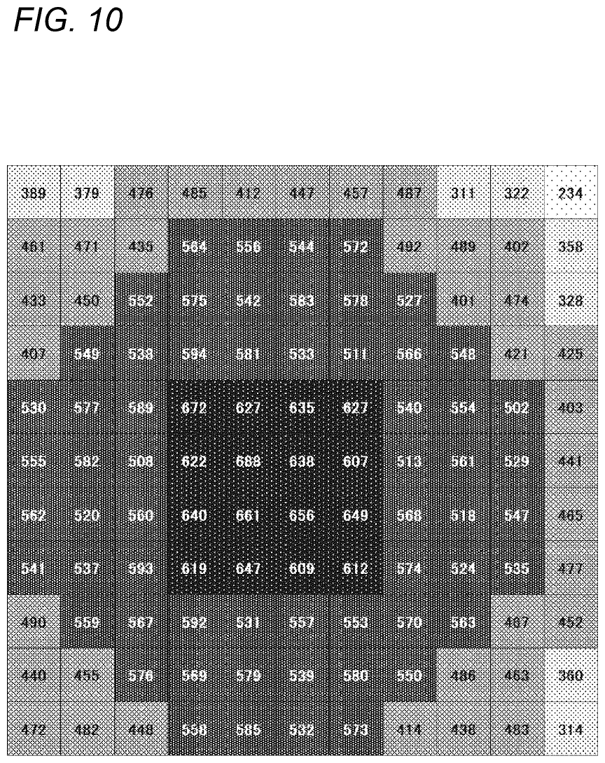

FIG. 10 is a diagram illustrating an example of simulation results of a power intensity generated at a receiver 200 placed at a predetermined position. In the example shown in FIG. 10, the presentation control unit 594 displays, in association with corresponding regions, the power intensity calculated for each grid-like region into which a space in which the WPT system 1 is constructed is divided. In addition, in the example shown in FIG. 10, the presentation control unit 594 displays each region divided in the grid-like manner in a mode corresponding to the calculated power intensity. For example, the presentation control unit 594 represents the intensity by hatching whose density corresponds to the power intensity. The mode may alternatively be a color, a pattern, or a combination thereof.

In FIG. 10, an example is shown in which the calculated power intensity is displayed in association with a corresponding grid-like region in the space, and a mode corresponding to the power intensity is applied. The presentation control unit 594 may alternatively overlay the power intensity on a floor map and apply a mode corresponding to the power intensity. Specifically, the presentation control unit 594 divides the floor map into predetermined regions, associates each region on the floor map with the power intensity calculated for that region, and applies to each region on the floor map a mode corresponding to the associated power intensity.

The presentation control unit 594 may also cause the display 541 to display, together with the power intensity and/or the mode representing the power intensity, available applications (e.g., a heat sensor, a temperature sensor, a light sensor, a humidity sensor, and a vibration sensor) based on the power intensity calculated for each region.

In the description of FIG. 6, a case has been described in which, in step S11, the operation acceptance unit 591 accepts inputs of information regarding the space, the number of the transmitters 100, and the placement of the transmitters 100. However, in step S11, the operation acceptance unit 591 may accept inputs other than the information regarding the space, the number of the transmitters 100, and the placement of the transmitters 100. For example, the operation acceptance unit 591 may accept inputs of a transmit power of the transmitter 100, a gain of the transmitting antenna 102, a gain of the receiving antenna 201, an efficiency of the rectifier 202, or any combination of at least some of these.

In step S13, the first computation unit 593 calculates the power intensity generated at the receiver 200 placed at the predetermined position based on the entered information. Specifically, for example, the first computation unit 593 simulates transmission of radio waves from the transmitters 100 placed at positions entered in the second region 5412, for the space entered in the first region 5411. Based on parameters such as the entered transmit power of the transmitter 100, the gain of the transmitting antenna 102, the gain of the receiving antenna 201, and the efficiency of the rectifier 202, the first computation unit 593 calculates, for receivers 200 placed in respective regions obtained by dividing the space into regions of a predetermined size, the power intensity generated by the radio waves transmitted from the transmitters 100.

In step S11, the operation acceptance unit 591 may accept, instead of the efficiency of the rectifier 202, an input of information regarding a load of an application executed by the receiver 200. In this case, in step S13, the first computation unit 593 calculates a strength of a power-supply signal received by the receiver 200. The first computation unit 593 references the rectifier information 582 using the calculated strength of the power-supply signal and the information regarding the application load, and derives the efficiency of the rectifier 202. The first computation unit 593 simulates transmission of radio waves from the transmitters 100 placed at positions entered in the second region 5412, for the space entered in the first region 5411. Based on parameters including the derived efficiency of the rectifier 202, the first computation unit 593 calculates the power intensity generated, by the radio waves transmitted from the transmitters 100, at the receivers 200 placed in respective regions obtained by dividing the space into regions of a predetermined size. The first computation unit 593 may alternatively calculate the efficiency of the rectifier 202 by substituting the calculated strength of the power-supply signal and the application load into a predetermined equation for calculating the efficiency of the rectifier 202.

In step S11, the operation acceptance unit 591 may accept an input of information regarding environmental conditions of the space. In this case, in step S13, the first computation unit 593 derives a radio-wave intensity loss (power-transfer efficiency factor) in the space based on the information regarding the environmental conditions. For example, the storage 580 stores a predetermined table for deriving the loss. In the table, for example, materials of members such as a floor, a ceiling, and walls in the space are associated with a radio-wave intensity loss. The first computation unit 593 references the table using the input information regarding the environmental conditions to derive the radio-wave intensity loss. Based on parameters including the derived radio-wave intensity loss, the first computation unit 593 calculates the power intensity generated, by the radio waves transmitted from the transmitters 100, at the receivers 200 placed in respective regions obtained by dividing the space into regions of a predetermined size. The first computation unit 593 may alternatively calculate a power-transfer efficiency by substituting the information regarding the environmental conditions into a predetermined equation for calculating the power-transfer efficiency.

In step S11, the operation acceptance unit 591 may also accept an input of information regarding obstacles such as desks, chairs, and shelves that may be placed in the space. In this case, in step S13, the first computation unit 593 derives a radio-wave intensity loss (power-transfer efficiency factor) in the space based on the information regarding the obstacles. For example, when an obstacle is present on a path from the transmitter 100 to the receiver 200, the first computation unit 593 reduces the power-transfer efficiency to a predetermined value. Based on parameters including the derived radio-wave intensity loss, the first computation unit 593 calculates the power intensity generated, by the radio waves transmitted from the transmitters 100, at the receivers 200 placed in respective regions obtained by dividing the space into regions of a predetermined size. The first computation unit 593 may alternatively calculate a power-transfer efficiency by substituting the information regarding the obstacles into a predetermined equation for calculating the power-transfer efficiency. In step S14, the presentation control unit 594 causes the power intensity calculated for each region obtained by dividing the space into regions of a predetermined size to be displayed on the display 541 together with an image regarding the obstacles.

As described above, in the embodiment, the operation acceptance unit 591 acquires information regarding the transmitters 100, which transmit a power-supply signal by radiating radio waves, to be placed in a predetermined space. The first computation unit 593 calculates, based on the information regarding the transmitters 100, the power intensity that becomes available at the receivers 200 that receive the power-supply signal at multiple positions in the space. The presentation control unit 594 presents a distribution of the calculated power intensity. Accordingly, it becomes possible to simulate a power intensity that becomes available to the receivers 200 by placing the transmitters 100.

Therefore, according to the embodiment, support can be provided for determining a placement of a wireless power transmission apparatus (transmitter) that supplies electric power wirelessly to a power-supply target.

In the embodiment, the operation acceptance unit 591 also acquires a power-transfer efficiency from the transmitter 100 to a position in the space and information regarding the receivers 200. Based on the information regarding the transmitters 100, the power-transfer efficiency, and the information regarding the receivers 200, the first computation unit 593 calculates the power intensity generated at the receivers 200 that receive the power-supply signal. Accordingly, because various parameters can be set by a user, accuracy of the simulation is improved.

In the embodiment, the operation acceptance unit 591 acquires, as information regarding the receivers 200, an efficiency of the rectifier 202 that rectifies received radio waves, based on a strength of radio waves received by the receiver 200 and a load related to the receiver 200. Accordingly, because the efficiency of the rectifier 202 is calculated in accordance with a situation of the receiver 200, accuracy of the simulation is improved.

In the embodiment, the operation acceptance unit 591 acquires information regarding obstacles placed in the space. The first computation unit 593 calculates the power intensity based on the information regarding the obstacles. Accordingly, it becomes possible to simulate the power intensity in a case where obstacles such as desks, chairs, and shelves are present, and thus to consider a placement of the transmitters 100 in an environment in which obstacles are present.

### Modification 1

In the embodiment described above, a case has been explained in which inputs from a user are accepted regarding information about a space, and number and a placement of the transmitters 100; however, acquisition of these items of information is not limited to user input. For example, the third information processing apparatus 500 may acquire information regarding a floor map and, based on the acquired floor-map information, set the information about the space and the number and placement of the transmitters 100.

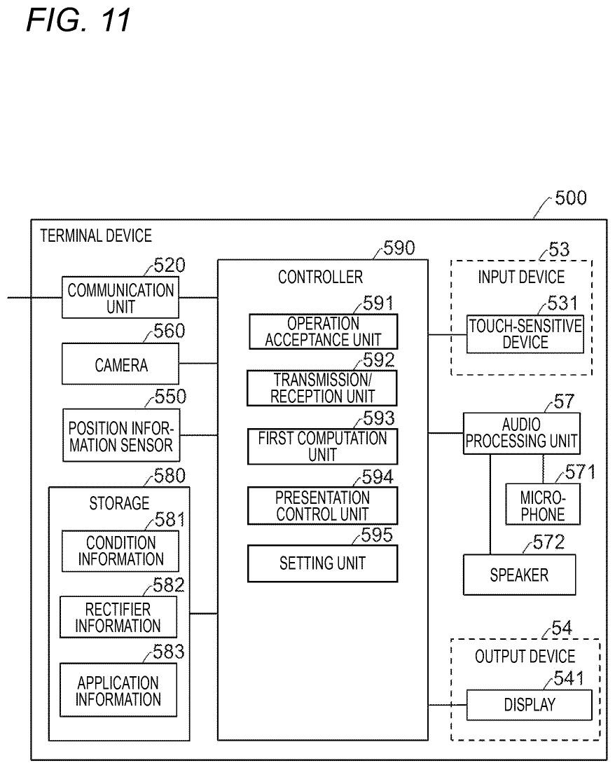

FIG. 11 is a block diagram illustrating an example configuration of the third information processing apparatus 500 according to Modification 1. In the example shown in FIG. 11, the controller 590 of the third information processing apparatus 500 has an operation acceptance unit 591, a transmission/reception unit 592, a first computation unit 593, a presentation control unit 594, and a setting unit 595.

The setting unit 595 sets the information about the space and the number and placement of the transmitters 100 based on, for example, floor-map information received by the operation acceptance unit 591. A floor map is, for example, a plan view representing the space. The plan view may include, for example, information regarding dimensions and information regarding obstacles. The floor map may alternatively be described as a diagram representing a state of the space. The floor-map information may be received by the transmission/reception unit 592. The setting unit 595 acquires the information about the space from the floor-map information and, based on the acquired space information, arranges the transmitters 100 in the space in accordance with a predetermined rule. The predetermined rule for arranging the transmitters 100 may be, for example, arranging the transmitters 100 in a grid at predetermined intervals. The setting unit 595 sets, as conditions related to the WPT system 1, the information about the space and information regarding the placement of the transmitters 100.

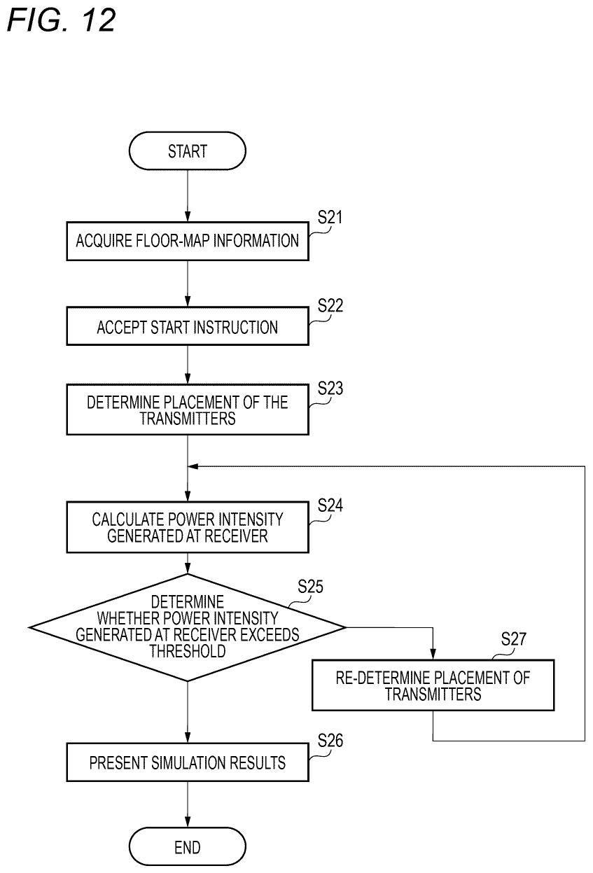

FIG. 12 is a flowchart illustrating another example operation of the third information processing apparatus 500 when performing a simulation regarding placement of the transmitters 100.

In step S21, the third information processing apparatus 500 acquires floor-map information from a user. Specifically, the controller 590 of the third information processing apparatus 500 causes, via the presentation control unit 594, an input form for entering floor-map information to be displayed on the display 541. The user operates the input device 53 and enters the floor-map information. The operation acceptance unit 591 accepts the information entered by the user. The floor-map information may be captured by a scanner or by photographing with a camera.

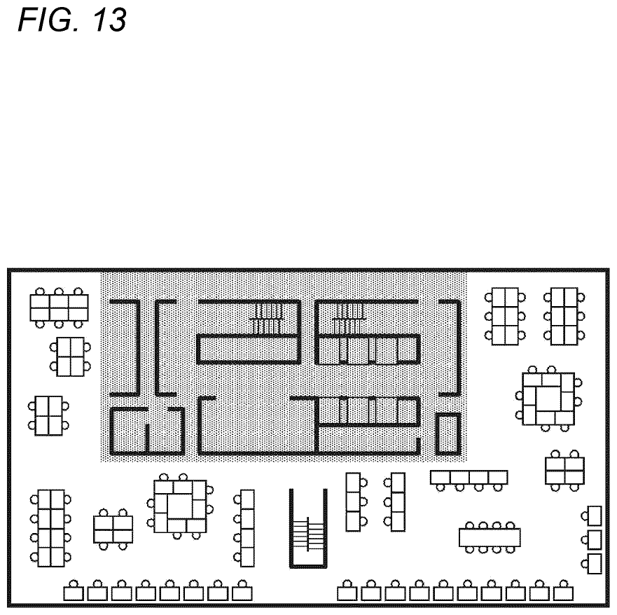

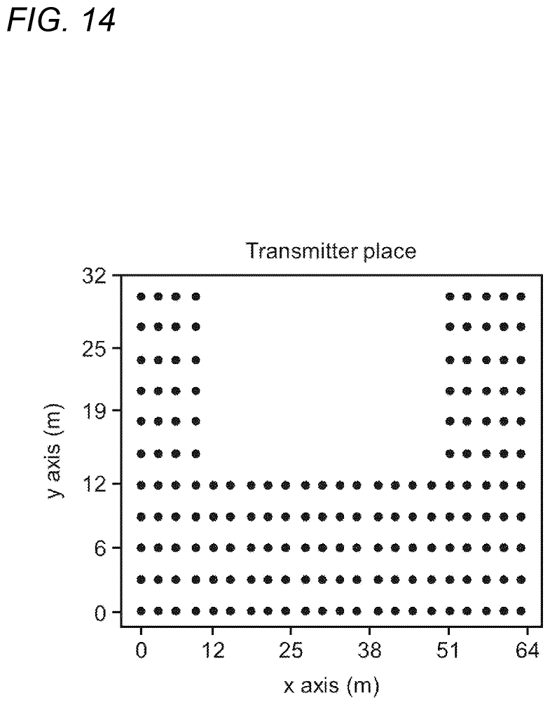

FIG. 13 is a diagram illustrating an example of floor-map information input by a user. In the example shown in FIG. 13, a shared area is excluded from the simulation target space because no power-supply environment is to be constructed there.

In step S22, the third information processing apparatus 500 accepts, from the user, a start instruction for the simulation. Specifically, for example, the presentation control unit 594 displays, in the input form, a control for starting a simulation regarding placement of the transmitters 100. After entering the floor-map information, the user presses the control. The operation acceptance unit 591 accepts the pressing of the control as a start instruction for the simulation.

In step S23, the third information processing apparatus 500 determines a placement of the transmitters 100. Specifically, for example, the controller 590 of the third information processing apparatus 500 causes the setting unit 595 to acquire, from the acquired floor-map information, information such as lengths of the space in the x and y directions. Based on the acquired information, the setting unit 595 arranges the transmitters 100 in the space in accordance with a predetermined rule. The setting unit 595 sets, as conditions related to the WPT system 1, the information about the space and the information regarding the placement of the transmitters 100. The presentation control unit 594 may generate and present to the user a diagram representing the placement of the transmitters 100.

FIG. 14 is a diagram illustrating an example placement of the transmitters 100 in the space. With reference to the diagram representing the placement of the transmitters 100, a user can intuitively grasp the placement of the transmitters 100.

In step S24, the third information processing apparatus 500 calculates a power intensity generated at a receiver 200 placed at a predetermined position by a power-supply signal transmitted from the transmitter 100. Specifically, for example, the controller 590 simulates, via the first computation unit 593, transmission of radio waves from the transmitters 100 arranged in accordance with the predetermined rule for the space recognized based on the floor map. Based on other parameters that have been preset, the first computation unit 593 calculates the power intensity generated, by the radio waves transmitted from the transmitters 100, at the receivers 200 placed in respective regions obtained by dividing the space into regions of a predetermined size.

In step S25, the third information processing apparatus 500 determines whether the power intensity generated at the receiver 200 satisfies predetermined requirements. Specifically, for example, the controller 590 of the third information processing apparatus 500 determines, via the first computation unit 593, whether the power intensity calculated for each region in the space satisfies predetermined requirements. The storage 580 stores, for example, a threshold for the power intensity for each region. The first computation unit 593 determines whether the power intensity calculated for each region exceeds the threshold set for the region. When the power intensity calculated for each region exceeds the threshold set for the region (Yes in step S25), the first computation unit 593 proceeds to step S26; when it does not exceed the threshold (No in step S25), the first computation unit 593 proceeds to step S27.

In step S26, the third information processing apparatus 500 presents simulation results to the user. Specifically, for example, the controller 590 causes, via the presentation control unit 594, the power intensity calculated for each region obtained by dividing the space into regions of a predetermined size to be displayed on the display 541.

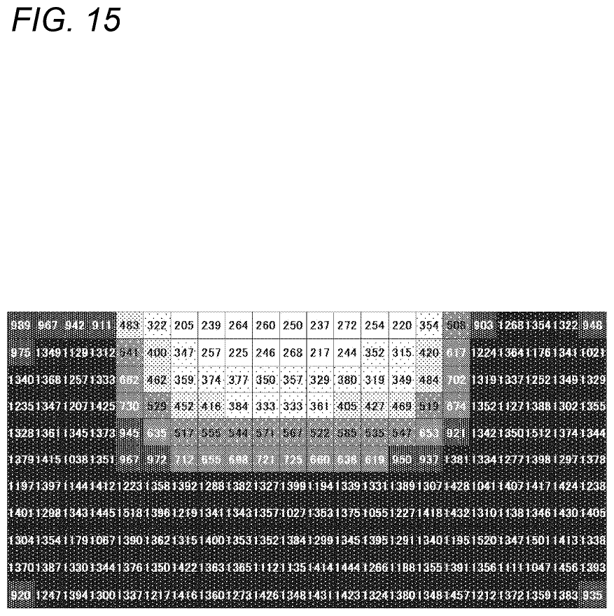

FIG. 15 is a diagram illustrating an example of simulation results of a power intensity generated at a receiver 200 placed at a predetermined position. In the example shown in FIG. 15, the presentation control unit 594 displays, in association with corresponding regions, the power intensity calculated for each grid-like region into which a space in which the WPT system 1 is constructed is divided. In addition, in the example shown in FIG. 15, the presentation control unit 594 displays each region divided in the grid-like manner in a mode corresponding to the calculated power intensity. For example, the presentation control unit 594 represents the intensity by hatching whose density corresponds to the power intensity.

The presentation control unit 594 may overlay the power intensity on a floor map and apply a mode corresponding to the power intensity.

The presentation control unit 594 may also cause the display 541 to display, together with the power intensity and/or the mode representing the power intensity, available applications based on the power intensity calculated for each region.

In step S27, the third information processing apparatus 500 determines a placement of the transmitters 100. Specifically, for example, the controller 590 of the third information processing apparatus 500 determines, via the setting unit 595 and based on the floor-map information that has been acquired, a placement of the transmitters 100 that results in a stronger power intensity than a previously determined placement. More specifically, the setting unit 595 arranges the transmitters 100 such that the transmitters 100 are substantially evenly dispersed while increasing the number of the transmitters 100. The setting unit 595 sets, as conditions related to the WPT system 1, the newly determined placement information of the transmitters 100. After determining the placement of the transmitters 100, the setting unit 595 shifts processing to step S24.

In the description of FIG. 12, a case has been described in which, in step S21, the operation acceptance unit 591 accepts inputs of floor-map information. However, in step S21, the operation acceptance unit 591 may accept inputs other than the floor-map information. For example, the operation acceptance unit 591 may accept inputs of a transmit power of the transmitter 100, a gain of the transmitting antenna 102, a gain of the receiving antenna 201, an efficiency of the rectifier 202, or any combination of at least some of these.

In step S24, the first computation unit 593 calculates the power intensity generated at the receiver 200 placed at the predetermined position based on the entered information. Specifically, for example, the first computation unit 593 simulates transmission of radio waves from one or more transmitters 100 arranged for the space based on the floor-map information. Based on parameters such as the entered transmit power of the transmitter 100, the gain of the transmitting antenna 102, the gain of the receiving antenna 201, and the efficiency of the rectifier 202, the first computation unit 593 calculates, for receivers 200 placed in respective regions obtained by dividing the space into regions of a predetermined size, the power intensity generated by the radio waves transmitted from the transmitters 100.

In step S21, the operation acceptance unit 591 may accept, instead of the efficiency of the rectifier 202, an input of information regarding a load of an application executed by the receiver 200. In this case, in step S24, the first computation unit 593 calculates a strength of a power-supply signal received by the receiver 200. The first computation unit 593 references the rectifier information 582 using the calculated strength of the power-supply signal and the information regarding the application load, and derives the efficiency of the rectifier 202. The first computation unit 593 simulates transmission of radio waves from one or more transmitters 100 arranged for the space based on the floor-map information. Based on parameters including the derived efficiency of the rectifier 202, the first computation unit 593 calculates the power intensity generated, by the radio waves transmitted from the transmitters 100, at the receivers 200 placed in respective regions obtained by dividing the space into regions of a predetermined size.

In step S21, the operation acceptance unit 591 may accept an input of information regarding environmental conditions of the space. In this case, in step S24, the first computation unit 593 derives a radio-wave intensity loss (power-transfer efficiency factor) in the space based on the information regarding the environmental conditions. For example, the storage 580 stores a predetermined table for deriving the loss. In the table, for example, materials of members such as a floor, a ceiling, and walls in the space are associated with a radio-wave intensity loss. The first computation unit 593 references the table using the input information regarding the environmental conditions to derive the radio-wave intensity loss. Based on parameters including the derived radio-wave intensity loss, the first computation unit 593 calculates the power intensity generated, by the radio waves transmitted from the transmitters 100, at the receivers 200 placed in respective regions obtained by dividing the space into regions of a predetermined size.

In step S21, the operation acceptance unit 591 may also acquire, based on the floor-map information, information regarding obstacles such as desks, chairs, and shelves to be placed in the space. In this case, in step S24, the first computation unit 593 derives a radio-wave intensity loss (power-transfer efficiency factor) in the space based on the information regarding the obstacles. For example, when an obstacle is present on a path from the transmitter 100 to the receiver 200, the first computation unit 593 reduces the power-transfer efficiency to a predetermined value. Based on parameters including the derived radio-wave intensity loss, the first computation unit 593 calculates the power intensity generated, by the radio waves transmitted from the transmitters 100, at the receivers 200 placed in respective regions obtained by dividing the space into regions of a predetermined size. In step S26, the presentation control unit 594 causes the power intensity calculated for each region obtained by dividing the space into regions of a predetermined size to be displayed on the display 541 together with an image regarding the obstacles.

As described above, in the embodiment, the operation acceptance unit 591 acquires information regarding a diagram (plan view) representing a state of the space. The setting unit 595 sets, as information regarding the transmitters, the number of transmitters to be arranged and positions at which the transmitters are to be arranged, based on the acquired diagram information. Accordingly, without the user entering the number and placement of transmitters by themself, it becomes possible to simulate the power intensity by merely entering the plan view.

In the embodiment, processing is repeated until the power intensity calculated for predetermined regions in the space satisfies predetermined requirements. Accordingly, even when positions of the transmitters 100 are determined based on the diagram representing the state of the space, a situation in which insufficient power occurs can be avoided.

### Modification 2

In the embodiment described above, a case has been explained in which the placement of the transmitters 100 in the space is determined first, and then a power intensity generated at receivers 200 placed in respective regions obtained by dividing the space into regions of a predetermined size is calculated based on radio waves transmitted from the transmitters 100 thus placed. However, the order is not limited to determining the placement of the transmitters 100 first. For example, the third information processing apparatus 500 may estimate power required by a desired application and determine the number and a placement of the transmitters 100 capable of supplying the estimated power.

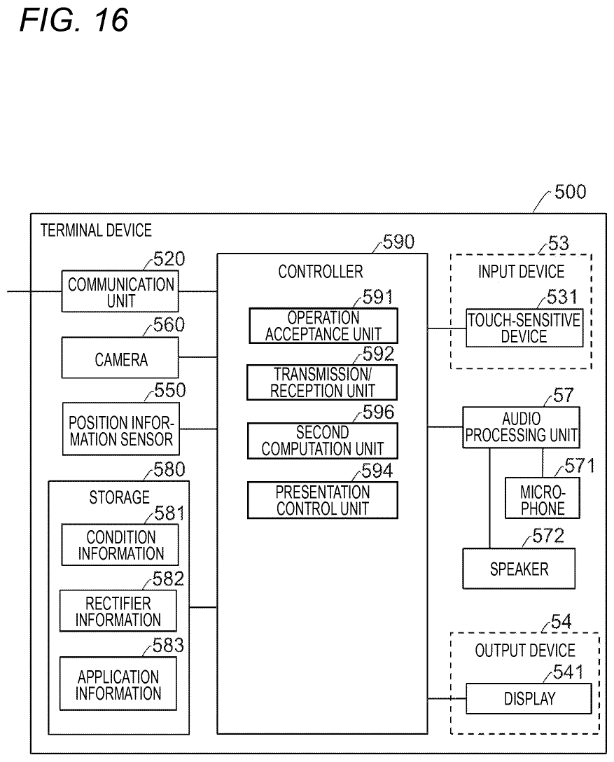

FIG. 16 is a block diagram illustrating an example configuration of the third information processing apparatus 500 according to Modification 2. In the example shown in FIG. 16, the controller 590 of the third information processing apparatus 500 has an operation acceptance unit 591, a transmission/reception unit 592, a second computation unit 596, and a presentation control unit 594.

The second computation unit 596 arranges the transmitters 100 in a predetermined space in which the WPT system 1 is constructed such that electric power usable by a user's desired application is generated. Specifically, for example, the second computation unit 596 calculates a power distribution with which the desired application becomes usable. The second computation unit 596 then determines a placement of the transmitters 100 in the space in which the WPT system 1 is constructed so as to satisfy the power distribution with which the desired application becomes usable.

The presentation control unit 594 controls the output device 54 to present simulation results to a user. Specifically, for example, the presentation control unit 594 causes the display 541 to display a placement of the transmitters 100 with which the desired application becomes usable. The presentation control unit 594 also causes the display 541 to display a distribution of power intensity generated at receivers 200 placed at predetermined positions by the power-supply signal transmitted from the arranged transmitters 100.

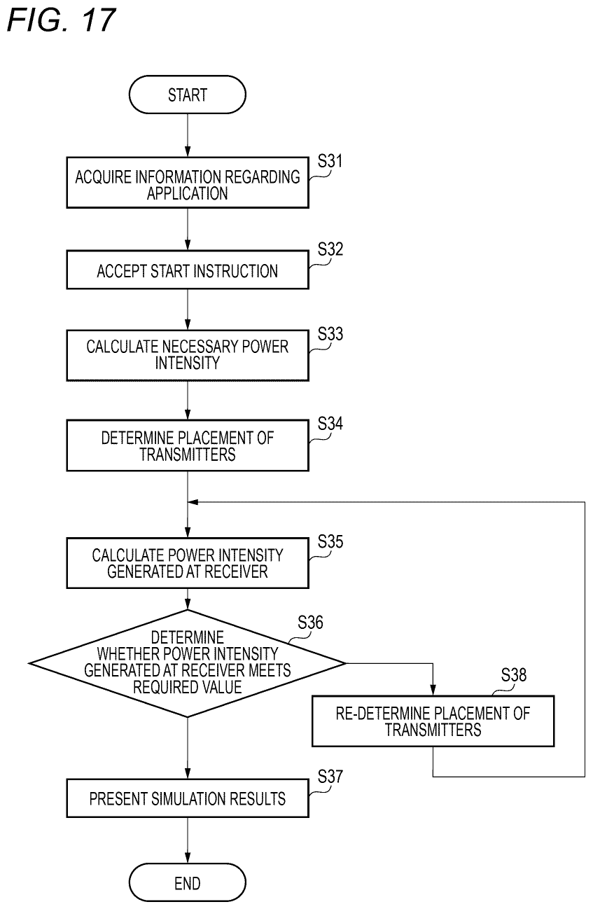

FIG. 17 is a flowchart illustrating another example operation of the third information processing apparatus 500 when performing a simulation regarding placement of the transmitters 100.

In step S31, the third information processing apparatus 500 acquires, from a user, information regarding applications. Specifically, the controller 590 of the third information processing apparatus 500 causes, via the presentation control unit 594, an input form for entering information regarding the space and information regarding applications to be displayed on the display 541. The user operates the input device 53 and enters the information regarding the space, and information regarding positions in the space at which applications are desired to be used and types of the applications. The operation acceptance unit 591 accepts the information entered by the user.

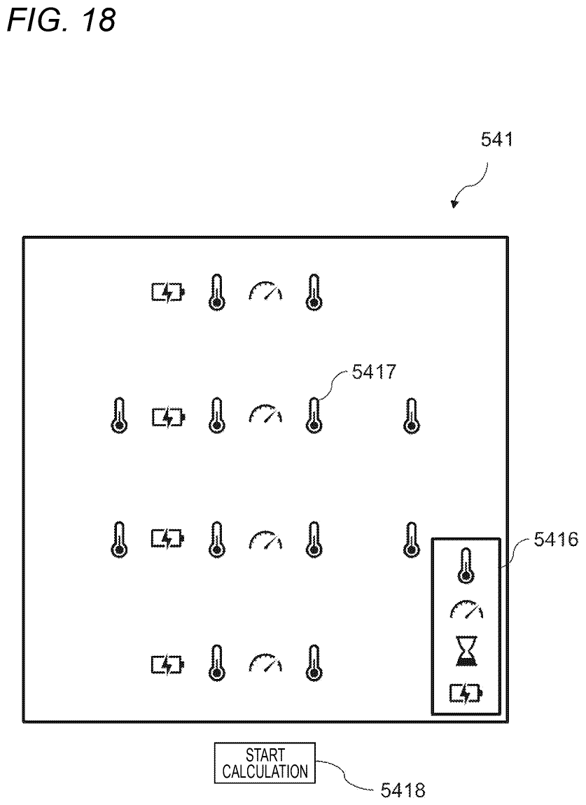

FIG. 18 is a schematic diagram illustrating an example display of the input form for information regarding applications. In the example shown in FIG. 18, a region 5416 for accepting selection of applications is displayed. The user selects an icon representing a desired application from the region 5416 and places the icon at a position in the space at which use is desired.

In step S32, the third information processing apparatus 500 accepts, from the user, a start instruction for the simulation. Specifically, in the example shown in FIG. 18, a control 5418 for starting a simulation regarding placement of the transmitters 100 is displayed. After selecting applications from the region 5416 and placing them in the space, the user presses the control 5418. The operation acceptance unit 591 accepts the pressing of the control 5418 as a start instruction for the simulation.

In step S33, the third information processing apparatus 500 calculates a power distribution with which the user's desired applications become usable. Specifically, the controller 590 of the third information processing apparatus 500 reads, via the second computation unit 596, loads of applications selected by the user from the application information 583. Based on positions at which the applications selected by the user are placed and the loads of the applications selected by the user, the second computation unit 596 calculates a power distribution with which the desired applications become usable.

In step S34, the third information processing apparatus 500 determines a placement of the transmitters 100 in the space in which the WPT system 1 is constructed. Specifically, the controller 590 causes, via the second computation unit 596, the transmitters 100 to be arranged in the space in accordance with a predetermined rule based on the information regarding the space entered by the user. The predetermined rule for arranging the transmitters 100 may be, for example, arranging the transmitters 100 in a grid at predetermined intervals. The information regarding the space may be extracted by analyzing the floor-map information.

In step S35, the third information processing apparatus 500 calculates a power intensity generated at a receiver 200 placed at a predetermined position by a power-supply signal transmitted from the transmitter 100. Specifically, for example, the controller 590 simulates, via the second computation unit 596, transmission of radio waves from the transmitters 100 arranged in accordance with the predetermined rule for the space recognized based on the floor map. Based on other parameters that have been preset, the second computation unit 596 calculates the power intensity generated, by the radio waves transmitted from the transmitters 100, at the receivers 200 placed in respective regions obtained by dividing the space into regions of a predetermined size.

In step S36, the third information processing apparatus 500 determines whether the power intensity generated at the receivers 200 satisfies a power intensity with which the applications can be used. Specifically, for example, the controller 590 determines, via the second computation unit 596, whether the power intensity calculated for each region in the space satisfies a power intensity with which the user's desired applications can be used. When the power intensity calculated for each region satisfies the power intensity with which the desired applications can be used (Yes in step S36), the second computation unit 596 proceeds to step S37; when it does not satisfy the power intensity (No in step S36), the second computation unit 596 proceeds to step S38.

In step S37, the third information processing apparatus 500 presents simulation results to the user. Specifically, for example, the controller 590 causes, via the presentation control unit 594, the placement of the transmitters 100 with which the desired applications can be used to be displayed on the display 541. The presentation control unit 594 also causes the display 541 to display a distribution of power intensity generated at receivers 200 placed at predetermined positions by the power-supply signal transmitted from the arranged transmitters 100.

FIG. 19 is a diagram illustrating an example of simulation results of the placement of the transmitters 100.

The presentation control unit 594 may overlay the simulation results of the placement of the transmitters 100 on a floor map.

In step S38, the third information processing apparatus 500 determines a placement of the transmitters 100. Specifically, for example, the controller 590 of the third information processing apparatus 500 determines, via the second computation unit 596 and based on the information regarding the space entered by the user, a placement of the transmitters 100 that results in a stronger power intensity than a previously determined placement. More specifically, the second computation unit 596 arranges the transmitters 100 such that the transmitters 100 are substantially evenly dispersed while increasing the number of the transmitters 100. After determining the placement of the transmitters 100, the second computation unit 596 shifts processing to step S35.

In the description of FIG. 17, a case has been described in which, in step S31, the operation acceptance unit 591 accepts inputs of information regarding applications. However, in step S31, the operation acceptance unit 591 may accept inputs other than the information regarding applications. For example, the operation acceptance unit 591 may accept inputs of a transmit power of the transmitter 100, a gain of the transmitting antenna 102, a gain of the receiving antenna 201, an efficiency of the rectifier 202, or any combination of at least some of these.

In step S35, the second computation unit 596 calculates the power intensity generated at the receiver 200 placed at the predetermined position based on the entered information. Specifically, for example, the second computation unit 596 simulates transmission of radio waves from one or more transmitters 100 arranged in the space. Based on parameters such as the entered transmit power of the transmitter 100, the gain of the transmitting antenna 102, the gain of the receiving antenna 201, and the efficiency of the rectifier 202, the second computation unit 596 calculates, for receivers 200 placed in respective regions obtained by dividing the space into regions of a predetermined size, the power intensity generated by the radio waves transmitted from the transmitters 100.

In step S31, the operation acceptance unit 591 may accept no input regarding the efficiency of the rectifier 202. In this case, in step S35, the second computation unit 596 calculates a strength of a power-supply signal received by the receiver 200. The second computation unit 596 references the rectifier information 582 using the calculated strength of the power-supply signal and the information regarding the application load, and derives the efficiency of the rectifier 202. The second computation unit 596 simulates transmission of radio waves from one or more transmitters 100 arranged in the space. Based on parameters including the derived efficiency of the rectifier 202, the second computation unit 596 calculates the power intensity generated, by the radio waves transmitted from the transmitters 100, at the receivers 200 placed in respective regions obtained by dividing the space into regions of a predetermined size.

In step S31, the operation acceptance unit 591 may accept an input of information regarding environmental conditions of the space. In this case, in step S35, the second computation unit 596 derives a radio-wave intensity loss (power-transfer efficiency factor) in the space based on the information regarding the environmental conditions. For example, the storage 580 stores a predetermined table for deriving the loss. In the table, for example, materials of members such as a floor, a ceiling, and walls in the space are associated with a radio-wave intensity loss. The second computation unit 596 references the table using the input information regarding the environmental conditions to derive the radio-wave intensity loss. Based on parameters including the derived radio-wave intensity loss, the second computation unit 596 calculates the power intensity generated, by the radio waves transmitted from the transmitters 100, at the receivers 200 placed in respective regions obtained by dividing the space into regions of a predetermined size.

In step S31, the operation acceptance unit 591 may also accept an input of information regarding obstacles such as desks, chairs, and shelves that may be placed in the space. In this case, in step S35, the second computation unit 596 derives a radio-wave intensity loss (power-transfer efficiency factor) in the space based on the information regarding the obstacles. For example, when an obstacle is present on a path from the transmitter 100 to the receiver 200, the second computation unit 596 reduces the power-transfer efficiency to a predetermined value. Based on parameters including the derived radio-wave intensity loss, the second computation unit 596 calculates the power intensity generated, by the radio waves transmitted from the transmitters 100, at the receivers 200 placed in respective regions obtained by dividing the space into regions of a predetermined size. The second computation unit 596 may alternatively calculate a power-transfer efficiency by substituting the information regarding the obstacles into a predetermined equation for calculating the power-transfer efficiency. In step S37, the presentation control unit 594 causes the power intensity calculated for each region obtained by dividing the space into regions of a predetermined size to be displayed on the display 541 together with an image regarding the obstacles.

The third information processing apparatus 500 may repeat determination of the placement of the transmitters 100 and calculation of the power intensity generated at the receivers 200 until the power intensity generated at the receivers 200 satisfies predetermined requirements.

As described above, in the embodiment, the operation acceptance unit 591 acquires information regarding the space, information regarding positions at which applications are used, and information regarding loads of the applications. Based on the acquired position information and load information, the second computation unit 596 determines positions of the transmitters 100 that supply, via radio waves, electric power usable by the applications. The presentation control unit 594 presents the determined positions of the transmitters 100. Accordingly, based on the desired applications to be used, it becomes possible to simulate a required number and positions of transmitters.

Therefore, according to the embodiment, support can be provided for determining a placement of a wireless power transmission apparatus (transmitter) that supplies electric power wirelessly to a power-supply target.

In the embodiment, the operation acceptance unit 591 also acquires a power-transfer efficiency from the transmitter 100 to a position in the space and information regarding the receiver 200 that receives the power-supply signal. Based on the position information, the load information, the power-transfer efficiency, and the information regarding the receiver 200, the second computation unit 596 determines the positions of the transmitters 100. Accordingly, because various parameters can be set by a user, accuracy of the simulation is improved.

In the embodiment, the operation acceptance unit 591 acquires, as information regarding the receiver 200, an efficiency of the rectifier 202 that rectifies received radio waves, based on a strength of radio waves received by the receiver 200 and a load of an application. Accordingly, because the efficiency of the rectifier 202 is calculated in accordance with a situation of the receiver 200, accuracy of the simulation is improved.

In the embodiment, the operation acceptance unit 591 acquires information regarding obstacles placed in the space. The second computation unit 596 determines positions of the transmitters 100 based on the information regarding the obstacles. Accordingly, it becomes possible to simulate the power intensity in a case where obstacles such as desks, chairs, and shelves are present, and thus to consider a placement of the transmitters 100 in an environment in which obstacles are present.

In the embodiment, the second computation unit 596 repeats determination of the positions of the transmitters until power generated by the power-supply signal in predetermined regions in the space satisfies predetermined requirements. Accordingly, even when positions of the transmitters 100 are determined based on desired applications, a situation in which regions with insufficient power occur can be avoided.

In the embodiment described above, a case has been explained in which a distribution of power intensity generated by the power-supply signal is represented in two dimensions. However, the third information processing apparatus 500 is not limited to representing the distribution of power intensity in two dimensions. By simulating the distribution of power intensity at multiple layer heights, the third information processing apparatus 500 may represent the distribution of power intensity in three dimensions. In this case, the third information processing apparatus 500 may represent, in two dimensions, the distribution of power intensity at each of the multiple heights.

### <4. Basic Hardware Configuration of Computer>

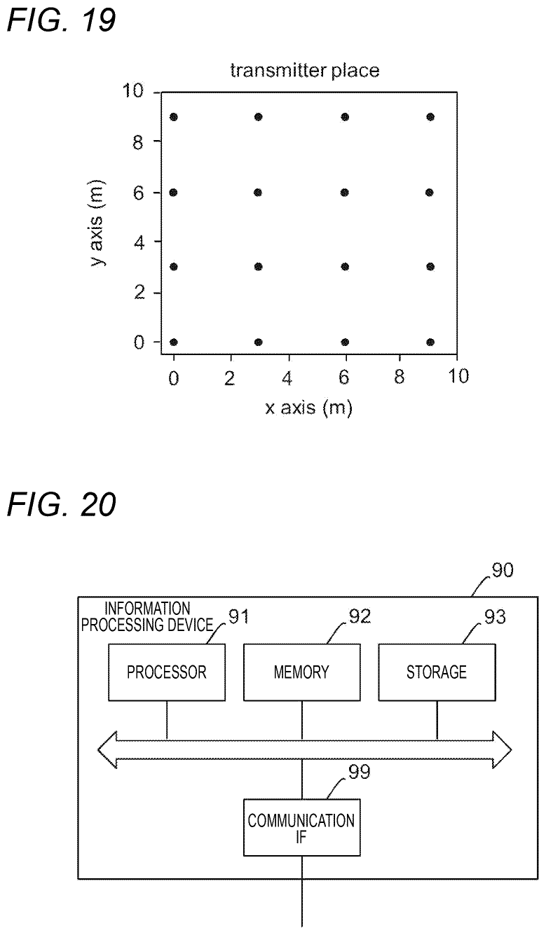

FIG. 20 is a block diagram illustrating a basic hardware configuration of a computer 90. The computer 90 includes at least a processor 91, a main storage 92, an auxiliary storage 93, and a communication interface (communication IF) 99. These are electrically connected to one another via a bus.

The processor 91 is hardware for executing an instruction set described in a program. The processor 91 includes, for example, an arithmetic unit, registers, and peripheral circuits.

The main storage 92 temporarily stores programs and data processed by programs. For example, the main storage 92 is a volatile memory such as a dynamic random access memory (DRAM).

The auxiliary storage 93 is a storage device that stores data and programs. Examples include a flash memory, a hard disk drive (HDD), a magneto-optical disk, a CD-ROM, a DVD-ROM, and a semiconductor memory.

The communication IF 99 is an interface for inputting and outputting signals for communicating, via a network, with another computer using a wired or wireless communication standard. The network may include the Internet, a LAN, and various mobile communication systems constructed by wireless base stations. Examples of the network include 3G, 4G, and 5G mobile communication systems, Long Term Evolution (LTE), and wireless networks (e.g., Wi-Fi) that can connect to the Internet via a predetermined access point. For wireless connections, examples of communication protocols include Z-Wave, Zigbee, and Bluetooth. For wired connections, the network may include a direct connection via a Universal Serial Bus (USB) cable.

Some or all of the hardware components may be provided in a distributed manner across multiple computers 90 and mutually connected via a network to virtually implement the computer 90. Thus, the computer 90 is a concept that includes not only a computer housed in a single enclosure or case but also a virtualized computer system.

### <Basic Functional Configuration of Computer 90>

A functional configuration of a computer realized by the basic hardware configuration of the computer 90 shown in FIG. 20 will be described. The computer includes at least functional units of a controller, a storage, and a communication unit.

The functional units included in the computer 90 may be implemented by distributing some or all of the respective functional units across a plurality of computers 90 that are mutually connected via a network. The computer 90 is a concept that includes not only a single computer 90 but also a virtualized computer system.

The controller is implemented when the processor 91 reads various programs stored in the auxiliary storage 93, loads them into the main storage 92, and executes processing in accordance with the programs. The controller can implement functional units that perform various kinds of information processing depending on the type of program. Thus, the computer is realized as an information processing apparatus that performs information processing.

The storage is implemented by the main storage 92 and the auxiliary storage 93. The storage stores data, various programs, and various databases. The processor 91 may, in accordance with the programs, secure a storage area corresponding to the storage in the main storage 92 and/or the auxiliary storage 93. In addition, in accordance with various programs, the controller can cause the processor 91 to execute processing for addition, update, and deletion of data stored in the storage.

The database refers to a relational database for associatively managing data sets, called tables, defined structurally in tabular form by rows and columns. In the database, tables are referred to as “tables,” columns as “columns,” and rows as “records.” In a relational database, relations among tables can be set and associated with one another. Typically, each table has a column set as a key for uniquely identifying records; however, setting a key for a column is not mandatory. In accordance with various programs, the controller can cause the processor 91 to add, delete, and update records in a specific table stored in the storage.

The communication unit is implemented by the communication IF 99. The communication unit implements a function to communicate with another computer 90 via a network. The communication unit can receive information transmitted from another computer 90 and input the received information to the controller. In accordance with various programs, the controller can cause the processor 91 to execute information processing on the received information. The communication unit can also transmit information output from the controller to another computer 90.

Although several embodiments of the present disclosure have been described above, these embodiments may be implemented in various other forms, and various omissions, replacements, and modifications may be made without departing from the gist of the invention. Such embodiments and modifications are also included within the scope and spirit of the invention, and are intended to be encompassed by the scope of the claims and equivalents thereof.

In the above description, “processor” means one or more processors. At least one processor is typically a microprocessor such as a CPU (Central Processing Unit), but another type of processor such as a GPU (Graphics Processing Unit) may be used. The at least one processor may be single-core or multi-core.

At least one processor may be a processor in a broad sense such as a hardware circuit that performs some or all processing (for example, an FPGA (Field-Programmable Gate Array) or an ASIC (Application Specific Integrated Circuit)).

In the above description, information for which an output is obtained in response to an input may sometimes be described using an expression such as “xxx table.” Such information may have any data structure, and may alternatively be a learned model such as a neural network that produces an output in response to an input. Accordingly, “xxx table” may be referred to as “xxx information.”

In the above description, the configurations of the respective tables are merely examples. One table may be divided into two or more tables, and all or some of two or more tables may be combined into one table.

In the description below, processing may sometimes be described with “program” as a grammatical subject. Because a program, when executed by a processor, performs prescribed processing using, as appropriate, the storage and/or interface units, the subject of the processing may instead be the processor (or a device having the processor, such as a controller or a microcontroller).

A program may be installed on a device such as a computer, and may reside on, for example, a program distribution server or a non-transitory computer-readable medium readable by a computer. In addition, in the description below, two or more programs may be implemented as a single program, and a single program may be implemented as two or more programs.

In the above description, identification numbers are used as identification information for various targets; however, identification information other than identification numbers (for example, identifiers including alphabetic characters and symbols) may be employed.

In the above description, when elements of the same kind are not distinguished from one another, reference numerals (or common portions of the reference numerals) may be used; when elements of the same kind are distinguished from one another, identification numbers (or reference numerals) of the elements may be used.

In the description below, control lines and information lines shown are those considered necessary for explanation, and not all control lines and information lines in an actual product are necessarily shown. All components may be interconnected.

### ADDITIONAL NOTES

The matters described in each of the above embodiments are additionally described below.

### Note 1

A non-transitory computer-readable storage medium storing a program for causing a computer to execute processing including: acquiring information regarding one or more transmitters configured to be placed in a predetermined space and configured to transmit a power-supply signal by radiating radio waves, and acquiring information regarding a power-transfer efficiency in the space; calculating, based on the information regarding the one or more transmitters and the information regarding the power-transfer efficiency, power intensity generated at one or more receivers configured to receive the power-supply signal at a plurality of positions in the space; and presenting a distribution of the calculated power intensity.

### Note 2

The non-transitory computer-readable storage medium of Note 1, in which the processing further includes: acquiring information regarding the one or more receivers; and calculating the power intensity based on the information regarding the one or more transmitters, the information regarding the power-transfer efficiency, and the information regarding the one or more receivers.

### Note 3

The non-transitory computer-readable storage medium of Note 2, in which the processing further includes: acquiring, as the information regarding the one or more receivers, an efficiency of a rectifier of at least one of the receivers, the rectifier being configured to rectify received radio waves, the efficiency being determined based on a strength of radio waves received by the at least one receiver and a load associated with the at least one receiver.

### Note 4

A non-transitory computer-readable storage medium storing a program for causing a computer to execute processing including: acquiring information regarding a space, information regarding positions at which applications are used, and information regarding loads of the applications; calculating, based on the information regarding the positions and the information regarding the loads of the applications, an amount of electric power usable by the applications;
determining positions in the space of one or more transmitters configured to supply, via radio waves, the calculated amount of electric power; and presenting the determined positions of the one or more transmitters.

### Note 5

The non-transitory computer-readable storage medium of Note 4, in which
acquiring includes: acquiring a power-transfer efficiency from at least one transmitter to a position in the space; and acquiring information regarding one or more receivers configured to receive radio waves; and in which determining the positions in the space of the one or more transmitters is based on the information regarding the positions at which the applications are used, the information regarding the loads of the applications, the power-transfer efficiency, and the information regarding the one or more receivers.

### Note 6

The non-transitory computer-readable storage medium of Note 5, in which the information regarding the one or more receivers includes an efficiency of a rectifier of at least one of the receivers, the rectifier being configured to rectify received radio waves, the efficiency being determined based on a strength of radio waves received by the at least one receiver and a load of at least one of the applications.

### Note 7

The non-transitory computer-readable storage medium in any one of Notes 4 to 6, in which acquiring further includes acquiring information regarding obstacles to be placed in the space, and in which determining the positions in the space of the one or more transmitters is based on the information regarding the obstacles.

### Note 8

The non-transitory computer-readable storage medium in any one of Notes 4 to 7, in which determining the positions in the space of the one or more transmitters is repeated until power generated by radio waves at each of a plurality of predetermined regions in the space satisfies predetermined requirements.

### Note 9

A non-transitory computer-readable storage medium storing a program for causing a computer to execute processing including: acquiring information regarding a plurality of transmitters configured to be placed in a predetermined space and configured to transmit a power-supply signal by radiating radio waves; calculating, based on the information regarding the plurality of transmitters, power intensity generated at one or more receivers that receive the power-supply signal at a plurality of positions in the space; and presenting a distribution of the calculated power intensity.

### Note 10

The non-transitory computer-readable storage medium of Note 9, in which the processing further includes: acquiring information regarding obstacles to be placed in the space; and calculating the power intensity based on the information regarding the obstacles.

### Note 11

The non-transitory computer-readable storage medium of Note 9, in which the processing further includes: acquiring information regarding a diagram representing a state of the space; and setting, based on the acquired information regarding the diagram, as the information regarding the plurality of transmitters, number of transmitters configured to transmit the power-supply signal by radiating radio waves and positions at which the transmitters are configured to be placed in the space.

### Note 12

The non-transitory computer-readable storage medium of Note 11, in which setting and calculating are repeated until the power intensity calculated for a predetermined region in the space satisfy predetermined requirements.

### Note 13

A computer-implemented method including executing, by a processor of a computer including the processor and a memory, the program stored on the non-transitory computer-readable storage medium in any one of Notes 1 to 12, thereby performing all of the operations recited in any one of Notes 1 to 12.

### Note 14

An information processing apparatus, including a controller and a storage, in which the controller is configured to execute the program stored on the non-transitory computer-readable storage medium in any one of Notes 1 to 12 so as to perform all of the operations recited in any one of Notes 1 to 12.

### Note 15

A system, including at least one processor and at least one memory storing instructions that, when executed by the at least one processor, cause the system to perform all of the operations recited in any one of Notes 1 to 12, the instructions including the program stored on the non-transitory computer-readable storage medium in any one of Notes 1 to 12.

What is claimed is:

1. A non-transitory computer-readable storage medium storing a program for causing a computer to execute processing comprising:
acquiring information regarding one or more transmitters configured to be placed in a predetermined space and configured to transmit a power-supply signal by radiating radio waves, and acquiring information regarding a power-transfer efficiency in the space;
calculating, based on the information regarding the one or more transmitters and the information regarding the power-transfer efficiency, power intensity generated at one or more receivers configured to receive the power-supply signal at a plurality of positions in the space; and
presenting a distribution of the calculated power intensity.

2. The non-transitory computer-readable storage medium of claim 1, wherein the processing further comprises:
acquiring information regarding the one or more receivers; and
calculating the power intensity based on the information regarding the one or more transmitters, the information regarding the power-transfer efficiency, and the information regarding the one or more receivers.

3. The non-transitory computer-readable storage medium of claim 2, wherein the processing further comprises:
acquiring, as the information regarding the one or more receivers, an efficiency of a rectifier of at least one of the receivers, the rectifier being configured to rectify received radio waves, the efficiency being determined based on a strength of radio waves received by the at least one receiver and a load associated with the at least one receiver.

4. A non-transitory computer-readable storage medium storing a program for causing a computer to execute processing comprising:
acquiring information regarding a space, information regarding positions at which applications are used, and information regarding loads of the applications;
calculating, based on the information regarding the positions and the information regarding the loads of the applications, an amount of electric power usable by the applications;
determining positions in the space of one or more transmitters configured to supply, via radio waves, the calculated amount of electric power; and
presenting the determined positions of the one or more transmitters.

5. The non-transitory computer-readable storage medium of claim 4, wherein the acquiring comprises:
acquiring a power-transfer efficiency from at least one transmitter to a position in the space; and
acquiring information regarding one or more receivers configured to receive radio waves; and
wherein the determining the positions in the space of the one or more transmitters is based on the information regarding the positions at which the applications are used, the information regarding the loads of the applications, the power-transfer efficiency, and the information regarding the one or more receivers.

6. The non-transitory computer-readable storage medium of claim 5, wherein the information regarding the one or more receivers comprises an efficiency of a rectifier of at least one of the receivers, the rectifier being configured to rectify received radio waves, the efficiency being determined based on a strength of radio waves received by the at least one receiver and a load of at least one of the applications.

7. The non-transitory computer-readable storage medium of claim 4, wherein the acquiring further comprises acquiring information regarding obstacles to be placed in the space, and wherein the determining the positions in the space of the one or more transmitters is based on the information regarding the obstacles.

8. The non-transitory computer-readable storage medium of claim 4, wherein the determining the positions in the space of the one or more transmitters is repeated until power generated by radio waves at each of a plurality of predetermined regions in the space satisfies predetermined requirements.

9. A non-transitory computer-readable storage medium storing a program for causing a computer to execute processing comprising:
acquiring information regarding a plurality of transmitters configured to be placed in a predetermined space and configured to transmit a power-supply signal by radiating radio waves;
calculating, based on the information regarding the plurality of transmitters, power intensity generated at one or more receivers that receive the power-supply signal at a plurality of positions in the space; and
presenting a distribution of the calculated power intensity.

10. The non-transitory computer-readable storage medium of claim 9, wherein the processing further comprises:
acquiring information regarding obstacles to be placed in the space; and
calculating the power intensity based on the information regarding the obstacles.

11. The non-transitory computer-readable storage medium of claim 9, wherein the processing further comprises:
acquiring information regarding a diagram representing a state of the space; and
setting, based on the acquired information regarding the diagram, as the information regarding the plurality of transmitters, number of transmitters configured to transmit the power-supply signal by radiating radio waves and positions at which the transmitters are configured to be placed in the space.

12. The non-transitory computer-readable storage medium of claim 11, wherein setting and calculating are repeated until the power intensity calculated for a predetermined region in the space satisfies predetermined requirements.

13. A computer-implemented method comprising:
the acquiring, the calculating and the presenting of claim 9.

14. An information processing apparatus comprising:
the computer and non-transitory computer-readable storage medium of claim 9.

15. A system comprising:
the non-transitory computer-readable storage medium of claim 9; and
at least one processor configured to execute the program stored in the non-transitory computer-readable storage medium.

16. The non-transitory computer-readable storage medium of claim 9, wherein the calculating comprises, for a plurality of receiver heights within the space, calculating power intensity at a plurality of positions in the space for one or more of the receivers; and
wherein the presenting comprises presenting at least one of:
(i) two-dimensional distributions of the power intensity, each distribution corresponding to a respective one of the plurality of receiver heights; and
(ii) a three-dimensional distribution of the power intensity across the space based on the plurality of receiver heights.
